(19) United States
(12) Patent Application Publication
(10) Pub. No.: US 2014/0204223 A1
(43) Pub. Date: Jul. 24, 2014

(54) METHOD OF CAPTURING REAL-LIFE COLORS

(71) Applicant: CHENG UEI PRECISION INDUSTRY CO., LTD., New Taipei City (TW)

(72) Inventors: Wen Ko Lin, New Taipei City (TW); Ting Kang Wong, New Taipei City (TW); Ya Fen Yao, New Taipei City (TW)

(73) Assignee: CHENG UEI PRECISION INDUSTRY CO., LTD., New Taipei City (TW)

(21) Appl. No.: 13/748,624

(22) Filed: Jan. 24, 2013

(51) Int. Cl. H04N 1/00

(52) U.S. Cl. CPC H04N 1/00244
USPC 348/207.1

(57) ABSTRACT

A method of capturing real-life colors is adapted for being achieved by a pen camera including a camera module which has a circuit board, a camera lens built in on the tip of a pen body, a shutter button and a power button. The method includes the steps of: actuating the power button to power on the camera module; pointing to an item directly with the camera lens, the item has the desired real-life color; actuating the shutter button to make the camera lens capture the item and be saved as a photo; transmitting the photo into a target console; utilizing an application processing software in the target console to extract the desired real-life color in the photo and then define the extracted color; renaming the defined color and being saved in the target console to make the defined color capable of being used in other painting or sketching operations.

### BACKGROUND OF THE INVENTION

1. Field of the Invention

The present invention generally relates to a method, and more particularly to a method of capturing real-life colors.

2. The Related Art

At present, with the rapid development of electronic technology, drawing software and graffiti software are widely applied in all kinds of electronic products. During using the drawing software or the graffiti software, users often select the appropriate color what they think for painting or sketching design actions. When there is no the desired color by the user in the default colors of software built-in color plate, the user will use the software built-in color plate to simulate real-life colors and customize a new color. However, for making the customized new color closer to the real-life colors, the user often needs to repeatedly try more colors from the software built-in color plate and repeatedly compare with the real-life colors. As a result, it need spend a lot of time to improve the simulation degree of the customized new color, but the customized new color still is hard to achieve the effect of the real-life color. Therefore, a method of capturing real-life colors is required.

### SUMMARY OF THE INVENTION

An object of the present invention is to provide a method of capturing real-life colors. The method is adapted for being achieved by a pen camera. The pen camera includes a pen body and a camera module. The camera module has a circuit board mounted inside the pen body, a camera lens built in on the tip of the pen body and electrically connecting with the circuit board, a shutter button embedded in the outer sidewall of the pen body and electrically connected to the circuit board, and a power button embedded in the outer sidewall of the pen body to control work states of the camera module.

The method includes the following steps.

Step 1: actuate the power button to power on the camera module of the pen camera.

Step 2: point to an item directly with the camera lens of the pen camera, wherein the item has the desired real-life color by the user.

Step 3: actuate the shutter button to make the camera lens capture the desired real-life color of the item and then be saved as a photo in the camera module, wherein the photo taken by the camera module shows the desired real-life color of the item in the form of patches of color.

Step 4: transmit the photo from the pen camera into a target console.

Step 5: utilize an application processing software in the target console to extract the desired real-life color in the photo and then define the extracted color.

Step 6: rename the defined color and then be saved in the target console to make the defined color capable of being used in other painting or sketching operations of the target console by user.

As described above, the method of the present invention utilizes the pen camera to capture the desired real-life colors and transmit the photo into the target console, and then utilizes the application processing software in the target console to extract and define the desired real-life colors, so that make the desired real-life colors capable of being conveniently used in other paining or sketching operations by the user.

### BRIEF DESCRIPTION OF THE DRAWINGS

The present invention will be apparent to those skilled in the art by reading the following description, with reference to the attached drawings, in which:

FIG. 1 and FIG. 2 are sketch views of a pen camera used to achieve a method of capturing real-life colors according to the present invention.

### DETAILED DESCRIPTION OF THE PREFERRED EMBODIMENT

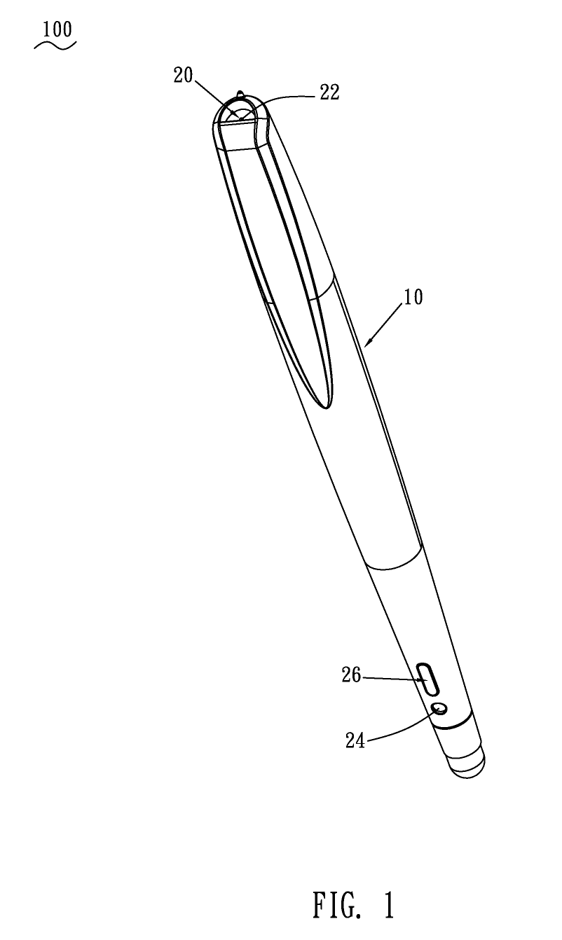

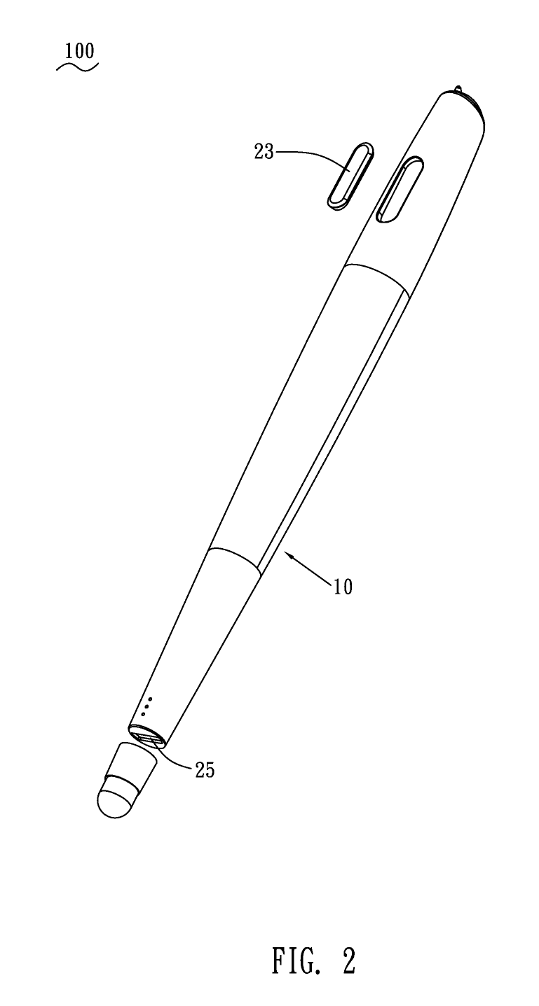

With reference to FIG. 1 and FIG. 2, a method of capturing real-life colors according to the present invention is adapted for being achieved by a pen camera 100. The pen camera 100 includes a pen body 10 and a camera module 20. The camera module 20 has a circuit board (not shown) mounted inside the pen body 10, a camera lens 22 built in on the tip of the pen body 10 and electrically connecting with the circuit board, a shutter button 23 embedded in the outer sidewall of the pen body 10 and electrically connected to the circuit board, and a power button 24 embedded in the outer sidewall of the pen body 10 to control work states of the camera module 20.

The method of capturing real-life colors with the pen camera 100 includes the following steps.

Step 1: actuate the power button 24 to power on the camera module 20 of the pen camera 100.

Step 2: point to an item directly with the camera lens 22 of the pen camera 100, wherein the item has the desired real-life color by the user.

Step 3: actuate the shutter button 23 to make the camera lens 22 capture the desired real-life color of the item and then be saved as a photo in the camera module 20, wherein the photo taken by the camera module 20 shows the desired real-life color of the item in the form of patches of color.

Step 4: transmit the photo from the pen camera 100 into a target console.

Step 5: utilize an application processing software in the target console to extract the desired real-life color in the photo and then define the extracted color by conducting minor adjustments on luminosity and transparency.

Step 6: rename the defined color and then be saved in the target console to make the defined color capable of being used in other painting or sketching operations of the target console by user.

Referring to FIG. 1 and FIG. 2 again, the pen camera 100 further includes a USB connector 25 and a wireless transmission unit 26. The USB connector 25 is disposed in a bottom end of the pen body 10 and electrically connected with the circuit board. The wireless transmission unit 26 is positioned on the circuit board and the pen body 10. In the method, the photo can be transmitted into the target console through a wired method or a wireless method, wherein the wired method is realized by the USB connector 25 and the wireless method is realized by the wireless transmission unit 26. The wireless transmission unit 26 is one of Wi-Fi module, Bluetooth module or NFC module.

As described above, the method of the present invention utilizes the pen camera 100 to capture the desired real-life colors and transmit the photo into the target console, and then utilizes the application processing software in the target console to extract and define the desired real-life colors, so that make the desired real-life colors capable of being conveniently used in other paining or sketching operations by the user.

What is claimed is:

1. A method of capturing real-life colors adapted for being achieved by a pen camera, the pen camera including a pen body and a camera module, the camera module having a circuit board mounted inside the pen body, a camera lens built in on the tip of the pen body and electrically connecting with the circuit board, a shutter button embedded in the outer sidewall of the pen body and electrically connected to the circuit board, and a power button embedded in the outer sidewall of the pen body to control work states of the camera module, the method comprising the steps of:
actuating the power button to power on the camera module of the pen camera;
pointing to an item directly with the camera lens of the pen camera, wherein the item has the desired real-life color by the user;
actuating the shutter button to make the camera lens capture the desired real-life color of the item and then be saved as a photo in the camera module, wherein the photo taken by the camera module shows the desired real-life color of the item in the form of patches of color;
transmitting the photo from the pen camera into a target console;
utilizing an application processing software in the target console to extract the desired real-life color in the photo and then define the extracted color; and
renaming the defined color and then being saved in the target console to make the defined color capable of being used in other painting or sketching operations of the target console by user.

2. The method as claimed in claim 1, wherein the application processing software in the target console defines the extracted color by conducting minor adjustments on luminosity and transparency.

3. The method as claimed in claim 1, wherein the photo is transmitted into the target console through a wired method, the wired method is realized by a USB connector disposed in a bottom end of the pen body and electrically connected with the circuit board.

4. The method as claimed in claim 1, wherein the photo is transmitted into the target console through a wireless method, the wireless method is realized by a wireless transmission unit positioned on the circuit board and the pen body.

5. The method as claimed in claim 4, wherein the wireless transmission unit is a Wi-Fi module, a Bluetooth module or a NFC module.
